(19) United States
(12) Patent Application Publication
(10) Pub. No.: US 2006/0258527 A1
(43) Pub. Date: Nov. 16, 2006

(54) Carbon monoxide tolerant electrochemical catalyst for proton exchange membrane fuel cell and method of preparing the same

(75) Inventors: Duck-young Yoo, Seoul (KR); Jianlu Zhang, Daillan (CN); Baolian Yi, Daillan (CN); Huamin Zhang, Daillan (CN)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/371,076

(22) Filed: Mar. 9, 2006

(30) Foreign Application Priority Data
Mar. 9, 2005 (CN) 200510045988.4
Feb. 21, 2006 (KR) 2006-16672

(51) Int. Cl. C01G 55/00

(52) U.S. Cl. 502/261

(57) ABSTRACT

A CO tolerant electrochemical catalyst for proton exchange membrane fuel cells (PEFC) and a method of preparing includes a PtAu-MₓO_{y}/C supported electrochemical catalyst for the PEFC. The electrochemical catalyst has high catalytic activity and has uniformly distributed active components. The method is simple, is easily managed, and is environmentally friendly.

### CROSS-REFERENCE TO RELATED PATENT APPLICATIONS

This application claims the benefit of Chinese Patent Application No. 200510045988.4, filed on Mar. 9, 2005 in the Chinese Intellectual Property Office, and Korean Patent Application No. 2006-16672, filed Feb. 21, 2006 in the Korean Intellectual Property Office, the disclosures of which are incorporated herein in their entirety by reference.

### BACKGROUND OF THE INVENTION

1. Field of the Invention

Aspects of the present invention relates to a CO tolerant electrochemical catalyst for a proton exchange membrane fuel cell (PEFC) and a method of preparing the same, and more particularly, to a PtAu-MₓO_{y}/C supported electrochemical catalyst for the PEFC and a method of preparing the same.

2. Description of the Related Art

Fuel cells have received significant attention in view of their advantages such as high efficiency, low emissions, and convenient starting. In particular, the PEFC, which generally operates at a low temperature of about 80° C. and are based on a polymer proton conducting membrane that acts as an electrolyte, have received more significant attention and are regarded as influential alternatives for vehicles and portable electronic products as power sources. The principle of the PEFC is as follows. A fuel cell includes an anode, a cathode, and a polymer electrolyte membrane that physically separates the anode and the cathode. Hydrogen is supplied to the anode and oxygen is supplied to the cathode. When the anode and the cathode are connected to form a circuit (for example, by being connected to an external power consumption circuit), an operation of the fuel cell is initiated.

In the anode, hydrogen is decomposed into 2 protons and 2 electrons as represented by formula 1 set forth below.
H₂→2H⁺+2e⁻ Formula 1

The produced proton easily migrates from the anode to the cathode through the polymer electrolyte membrane. However, the polymer electrolyte membrane is an electric insulator which prevents the electron from also migrating from the anode to the cathode.

In the cathode, oxygen is reduced as represented by formula 2 set forth below.
O₂+4H⁺+4e⁻→2H₂O Formula 2

In summary, the operation of the fuel cell is that hydrogen supplied to the anode combines with oxygen supplied to the cathode to produce water and electric energy.

Reactions in the electrodes of the PEFC are caused by an electrocatalyst, which is one of essential materials of the PEFC. Fast oxidation of hydrogen occurs in the anode. Although pure hydrogen is an ideal fuel of PEFC, it is expensive and has limitations in terms of storage and transportation. Currently, as alternatives thereto, reformed gas is used or hydrogen is directly prepared from methanol or other liquid fuels in vehicles, etc. However, the reformed gas or hydrogen prepared from methanol or other liquid fuels inevitably contains more or less carbon monoxide (CO) (up to 1 vol. %) according to a degree of purification. CO has higher affinity to a Pt catalyst, which is used in most fuel cells, than hydrogen. When CO-containing hydrogen is used, CO molecules occupy a specific active site of a Pt catalyst surface, resulting in a reduction in accessibility of hydrogen molecules to the active site. As a result, the fuel cell has reduced efficiency. This result is called “the poisoning” of a catalyst.

Recently, many CO tolerant electrochemical catalysts containing other components have been prepared using various methods. These electrochemical catalysts are bi-component or multi-component catalysts which are primarily composed of Pt, Ru, Rh, Pd, Ir, W, Mo, Sn, Mn and the like. A PtRu catalyst has the best CO tolerance, and thus has been widely used for PEFC and direct methanol fuel cells (DMFC). A CO tolerant PtRu/C electrochemical catalyst has the following disadvantages.
1) The catalyst contains a large amount of Pt and Ru.
2) Pt and Ru, which are expensive noble metals, increase the price of electrochemical catalyst, which is an obstacle to commercialization of PEFC.
3) Excessive dependence on PtRu/C as a CO tolerant catalyst is not helpful to development of PEFC.

In contrast to Pt group metal catalysts, an Au supported catalyst intrinsically has higher activity to CO oxidation than H₂ oxidation. Furthermore, catalytic activity of Au is improved by moisture and is insusceptible to carbon dioxide. Thus, research is being performed into use of the Au supported catalyst in the PEFC field. Pt—Au/ZnO, Au/MnOₓ, Au/CeO₂, and Au/Fe₂O₃ are reported as catalysts which remove CO in the presence of oxygen from a hydrogen-rich fuel into a fuel cell before being introduced. However, Au has not been reported as an active component of a CO tolerant catalyst.

The PEFC catalyst is prepared using any one of an impregnation-reduction method, a colloidal method, and a Bonnemann method. The impregnation-reduction method includes, for example, reducing an aqueous solution of a precursor of a metal such as Pt and depositing the metal onto a carbon support. Alternatively, an active metal precursor is reduced prior to impregnation on the carbon support and the reduced metal is deposited on a carbon support. NaBH₄, HCHO, HCOOH, HCOONa, N₂H₄ and the like are used as reducing agents. A PtRuPd/C catalyst prepared using Na₂S₂O₃ as a reducing agent is disclosed in U.S. Pat. No. 5,208,207. The impregnation-reduction method provides non-uniform catalysts since it is difficult to control the preparation conditions, such as solvent and pH conditions.

The colloidal method includes preparing a colloidal metal oxide, depositing the colloidal metal oxide onto the carbon support, and treating the resultant to obtain a catalyst. A Pt/C catalyst prepared using the colloidal method is disclosed in U.S. Pat. No. 3,992,331. First, chloroplatinic acid is converted into Na₆[Pt(SO₃)₄]. Then, Na⁺ of Na₆[Pt(SO₃)₄] is substituted with H⁺ through ion exchange. H₆[Pt(SO₃)₄] is heated to separate SO₃²⁻ and dried to obtain a colloidal Pt oxide. This colloid has a black color and a dispersion thereof in water or other solvents can be easily deposited onto a support.

M. Watanabe prepared a PtRu/C catalyst using the colloidal method (J. Electroanal. Chem., 229 (1987) 395). First, chloroplatinic acid is converted into Na₆[Pt(SO₃)₄]. Then, Na₆[Pt(SO₃)₄] is decomposed by adding excess H₂O₂ to obtain Pt oxide in a stable colloidal phase. A Ru compound such as RuCl₃ is added to the colloidal Pt oxide and Ru is oxidized into Ru oxide. Then, metal clusters are formed due to interaction between the Ru oxide and the Pt oxide. The clusters are deposited onto a support and the metals are reduced with hydrogen.

A. K. Shukla also prepared a PtRu/C catalyst using the colloidal method (A. K. Shukla, J. Appl. Electrochem., 29 (1999) 129). Precursors of Pt and Ru are individually converted into Na₆[Pt(SO₃)₄] and Na₆[Ru(SO₃)₄] and separated. Then, Na₆[Pt(SO₃)₄] and Na₆[Ru(SO₃)₄] are mixed and oxidized with H₂O₂ to obtain a mixture of colloidal metal oxides. Finally, the mixture is deposited onto a support.

U.S. Pat. No. 5,641,723 discloses a method of preparing a PEFC electrochemical catalyst using the Bonnemann method. In the Bonneman method, a PtRh/C catalyst is prepared in saturated C₅-C₁₀ hydrocarbon, aromatic hydrocarbon, ethers, esters, and ketones, more specifically n-pentane, hexane, benzene, toluene, THF, diethyl ether acetone, ethyl acetate, or a mixture thereof. Water and oxygen cannot be used in the method. Moreover, the method is complicated and expensive.

### SUMMARY OF THE INVENTION

An aspect of the present invention provides a CO tolerant electrocatalyst which has a high catalytic activity, has active components uniformly distributed therein, is simply prepared, is easily handled, and is environmentally friendly.

An aspect of the present invention also provides a method of preparing the electrocatalyst.

In an aspect of the present invention, a PtAu-MxOy/C electrochemical catalyst is prepared by introducing Au into PVC using an incipient wetness method.

In an aspect of the present invention, the PtAu-MxOy/C electrocatalyst is used in a single PEFC to achieve good CO tolerance.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other features and advantages of the present invention will become more apparent and more readily appreciated by describing in detail exemplary embodiments thereof with reference to the accompanying drawings in which:

FIG. 1 is a graph illustrating the performance of a single PEFC unit, in which a 5.4 wt % Pt-0.51 wt % Au-2.86 wt % Fe₂O₃/C catalyst and a 20 wt % Pt/C catalyst are used as anode catalysts, 100 ppm CO/H₂ is used as a fuel, and oxygen is used as an oxidant;

FIG. 2 is a graph illustrating performance of a PEFC, in which a 27.4 wt % Pt-0.51 wt % Au-2.86 wt % Fe₂O₃/C catalyst is used as an anode catalyst, 50 ppm CO/H₂ is used as a fuel, and oxygen is used as an oxidant;

FIG. 3 is a graph illustrating performance of a PEFC, in which a 29.1 wt % Pt-0.052 wt % Au-2.91 wt % Al₂O₃/C catalyst is used as an anode catalyst, 50 ppm CO/H₂ is used as a fuel, and oxygen is used as an oxidant;

FIG. 4 is a scanning electron microscopic (SEM) image of a 29.1 wt % Pt-0.052 wt % Au-2.91 wt % Al₂O₃/C catalyst; and

FIG. 5 is an example of a fuel cell according to an aspect of the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention relate to a new type of CO tolerant catalyst for a PEFC, including PtAu-MₓO_{y}, in which x is 1, 2, or 3, y is 1, 2, 3, or 4, and M is at least one transition metal selected from Fe, Al, Si, Ti, Zr, Mn, Ce, and Co, and a method of preparing the same. In particular and while not required in all aspects, MₓO_{y} is an oxide selected from Fe₂O₃, Al₂O₃, SiO₂, TiO₂, ZrO₂, MnO₂, CeO₂, Fe₃O₄, and Co₃O₄ according to an aspect of the invention

According to an aspect of the invention, the support for the catalyst is an activated carbon, conductive carbon, graphite, nano-carbon tube, nano-carbon fiber, or carbon molecular sieve. While not required in all aspects, a Pt/C catalyst which is supported on the above-described supports and contains 5-60 wt % of Pt is used as the support.

According to an aspect of the invention, the supported catalyst is prepared as follows. First, a precursor of active component is dissolved in an alcohol solvent. The solution is mixed with a catalyst support using, for example, an incipient wetness method. Then, the mixture is heated to 50-95° C. under stirring and dried in a vacuum at 60-150° C. for 2-24 hours. Finally, the dried mixture are thermally treated under H₂/inert gas atmosphere at 200-600° C. for 0.5-12 hours. The method of the aspect of the present invention can provide various CO tolerant catalysts which have a high catalytic efficiency and has an active component uniformly distributed therein. Moreover, the method is simple, is easily managed, and is environmentally friendly, and can be widely used to prepare various catalysts.

A conventional CO tolerant PtRu/C electrochemical catalyst has the following disadvantages.
1) The catalyst contains a large amount of Pt and Ru.
2) Pt and Ru, which are expensive noble metals, increase the price of electrochemical catalyst and are an obstacle to commercialization of PEFC.
3) Excessive dependence on PtRu/C as a CO tolerant catalyst is not helpful to development of PEFC.

An impregnation-reduction method generally provides non-uniform catalysts since it is difficult to control preparation conditions such as solvent and pH. A colloidal method is very complicated and is difficult to be industrialized. A Bonnemann method does not work in the presence water and oxygen, is not environmentally friendly, is complicated, and is expensive.

In contrast, aspects of the present invention provide a new type of CO tolerant electrochemical catalyst having high activity and a method of preparing the same.

According to an aspect of the invention, a CO tolerant electrochemical catalyst comprises PtAu-MₓO_{y}, in which x is 1, 2, or 3 and y is 1, 2, 3, or 4, supported on a support. In the supported catalyst and while not required in all aspects, MₓO_{y} may be an oxide selected from Fe₂O₃, Al₂O₃, SiO₂, TiO₂, ZrO₂, MnO₂, CeO₂, Fe₃O₄, Co₃O₄ or combinations thereof. The supported catalyst contains 5-60 wt % of Pt, 0.01-10 wt % of Au, and 0.1-20 wt % of MₓO_{y}, based on a total weight of the supported catalyst.

When the amount of Pt in the supported catalyst is less than 5 wt % of the total weight, the activity of the catalyst is insufficient and when the amount of Pt in the supported catalyst is greater than 60 wt % of the total weight, the amount of Pt is not cost-effective. When the amount of Au is less than 0.01 wt % of the total weight, CO tolerance of the catalyst is insufficient and when the amount of Au is greater than 10 wt % of the total weight, the amount is not cost-effective. When the amount of MₓO_{y} is less than 0.1 wt % of the total weight, metal catalysts are poorly dispersed and when the amount of MₓO_{y} is greater than 20 wt % of the total weight, the activity of the catalyst may be insufficient. However, while not cost effective, it is understood that amounts of Pt in excess of 60 wt % and/or amounts of Au in excess 10% are technically feasible.

The supported catalyst can be prepared using an incipient wetness method, an impregnation-reduction method, a colloidal method, a Sol-Gel method, a Bonnemann method, or other methods of preparing catalysts according to aspects of the invention.

A method of preparing catalysts according to an aspect of the invention includes: dissolving a Pt precursor and an Au precursor (including an additive including element M or M precursor suitable to form the resulting MₓO_{y}) in a solvent including an alcohol or a mixture of water and an alcohol to form a uniform solution of active components; mixing the solution and a support; surface-drying the mixture by heating the mixture to evaporate the solvent and completely drying the mixture at a higher temperature than the surface-drying temperature; and performing a thermal treatment on the mixture under H₂/inert gas atmosphere.

The support is generally activated carbon, conductive carbon, graphite, nano-carbon tube, nano-carbon fiber, carbon molecular sieve, or a Pt/C catalyst which is supported on the above-described supports and contains 5-60 wt % of Pt according to aspects of the invention. However, other supports can be used.

While not required in all aspects of the invention, the solvent may be a C₂-C₈ binary alcohol, a C₂-C₈ ternary alcohol, or a mixture of a C₂-C₈ binary alcohol or a C₂-C₈ ternary alcohol and water. That is, the C₂-C₈ binary alcohol or the C₂-C₈ ternary alcohol may contain 0-60 vol % of water. For example, the solvent may be ethylene glycol or an aqueous solution thereof. Ethylene glycol not only acts as a solvent, but also acts as a ligand in the method.

The case where a solvent contains 0 vol % of water indicates that the C₂-C₈ binary alcohol or a C₂-C₈ ternary alcohol without water is used as the solvent. When the content of water in the solvent is greater than 60 vol %, the supported catalyst is not easily formed due to a too low content of the alcohol, which acts as a solvent and a ligand.

The Pt precursor and the Au precursor are dissolved in the solvent to form a uniform solution. In the incipient wetness method, the amount of the solution is the maximum amount of the solution that can be absorbed by the support. The support which has absorbed the solution is heated to 50-95° C. while being stirred, and the solvent is evaporated until the surface of the mixture is dried. When the surface-drying temperature is lower than 50° C., drying is insufficient and when the surface-drying temperature is higher than 95° C., the support is damaged due to excessive drying.

The dried mixture is heated and dried at a higher temperature than the surface-drying temperature in a vacuum to more completely remove the solvent. This drying process may be performed at 60-150° C. for 2-24 hours. When the drying temperature is lower than 60° C., drying is insufficient and when the drying temperature is higher than 150° C., the support is damaged due to excessive drying. When the drying time is shorter than 2 hours, drying is insufficient and when the drying time is longer than 24 hours, it is not cost-effective. However, it is understood that other temperatures and times can be used.

The thermal treatment may be performed under inert gas atmosphere optionally containing reductive gas. The inert gas may be Ar, He, or N₂, but it is understood that other like gasses can be used. Fractions of the hydrogen in the H₂/inert gas mixture may be 0-90 vol % of the mixture. When the fraction of hydrogen is greater than 90 vol %, the size of a catalytic metal particle is significantly increased due to excessive reduction.

In the thermal treatment according to an aspect of the invention, a heating rate may be 0.1-20° C./min and a thermal treatment temperature is 200-600° C. When the heating rate is less than 0.1° C./min, it takes too long a time to increase the temperature to the thermal treatment temperature and when the heating rate is greater than 20° C./min, the size of a catalytic metal particle is significantly increased. When the thermal treatment temperature is lower than 200° C., the catalyst is not easily reduced and when the thermal treatment temperature is higher than 600° C., the size of a catalytic metal particle is significantly increased. However, it is understood that other rates and temperatures are possible.

Also, the thermal treatment may be performed for 0.5-12 hours according to aspects of the invention. When the thermal treatment time is shorter than 0.5 hour, the catalyst is not easily reduced and when the thermal treatment time is longer than 12 hours, the size of a catalytic metal particle is significantly increased. However, it is understood that other times are possible.

The MₓO_{y} additive can effectively disperse Au and prevent metals from sintering.

Since the solution of active components on the complex compound of ethylene glycol is homogeneous before being deposited on the support, the metals are uniformly distributed in the catalyst. The metal complex compound of ethylene glycol is easily decomposed at a relatively low temperature and any impurities are not introduced in the method. The method of preparing a catalyst is simple and is easily managed.

The method of the present embodiment has at least the following advantages as compared to conventional methods.
1. Various CO tolerant catalysts are provided;
2. The MₓO_{y} additive can effectively disperse Au and prevent metals from sintering;
3. A preparation process of catalysts is simple and can be easily managed and industrialized;
4. No impurities are introduced while preparing the catalyst;
5. Since the solution of active components on complex compound of ethylene glycol is homogeneous before deposited on the support, metals are uniformly distributed in the catalyst and the interaction between metals is very strong; and/or
6. The method of the present embodiment can be used to prepare an oxygen-reducing catalyst of a cathode for PEFC as well as the CO tolerant catalyst. The method can also be used to prepare a binary or multi-component catalyst.

The CO tolerant catalyst according to an embodiment of the present invention is simply prepared and easily handled. Moreover, the CO tolerant catalyst is environmentally friendly, has high catalytic efficiency, and has active components uniformly distributed therein. The CO tolerant catalyst is a new type of catalyst, and thus broadens the selection of potential catalysts.

Aspects of the present invention will now be described in greater detail with reference to the following examples. The following examples are for illustrative purposes and are not intended to limit the scope of the invention.

### EXAMPLE 1

### 19.2 wt % Pt-0.076 wt % Au-4.1 wt % Al₂O₃/C Electrochemical Catalyst of an Example of the Present Invention

3.3 mg of HAuCl₄.4H₂O and 0.63 g of Al(NO₃)₃.9H₂O were dissolved in 5 mL of an aqueous solution of ethylene glycol (water content 1.0 vol %) to prepare a uniform solution. 2.0 g of 20 wt % Pt/C catalyst was added to the solution and stirred for 1 hour to prepare a uniform mixture. The mixture was heated to 60° C. to evaporate the solvent until the surface of the mixture was dried. Then, the mixture was dried in a vacuum at 110° C. for 8 hours. Finally, the dried mixture was heated at a rate of 20° C./min and thermally treated at 600° C. for 4 hours under 2 vol % H₂/N₂ atmosphere.

### EXAMPLE 2

### 28.7 wt % Pt-0.076 wt % Au-4.1 wt % Al₂O₃/C Electrochemical Catalyst of an Example of the Present Invention

3.3 mg of HAuCl₄.4H₂O and 0.63 g of Al(NO₃)₃.9H₂O were dissolved in 5 mL of an aqueous solution of ethylene glycol (water content 1.0 vol %) to prepare a uniform solution. 2.0 g of 30 wt % Pt/C catalyst was added to the solution and stirred for 1 hour to prepare a uniform mixture. The mixture was heated to 60° C. to evaporate the solvent until the surface of the mixture was dried. Then, the mixture was dried in a vacuum at 130° C. for 4 hours. Finally, the dried mixture was heated at a rate of 5° C./min and thermally treated at 500° C. for 2 hours under 5 vol % H₂/N₂ atmosphere.

### EXAMPLE 3

### 29.1 wt % Pt-0.052 wt % Au-2.91 wt % Al₂O₃/C Electrochemical Catalyst of an Example of the Present Invention

3.3 mg of HAuCl₄.4H₂O and 0.63 g of Al(NO₃)₃.9H₂O were dissolved in 2 mL of ethylene glycol and mixed with an aqueous solution of H₂PtCl₆.6H₂O in ethylene glycol (7.586×10⁻⁴ mol Pt/mL) to prepare a uniform mixed solution. 2.0 g of Vulcan XC-72 conductive carbon (BET surface area 235 m²/g) was added to the solution and stirred for 1 hour to prepare a uniform mixture. The mixture was heated to 95° C. to evaporate the solvent until the surface of the mixture was dried. Then, the mixture was dried in a vacuum at 150° C. for 2 hours. Finally, the dried mixture was heated at a rate of 10° C./min and thermally treated at 600° C. for 1 hour under 20 vol % H₂/Ar atmosphere.

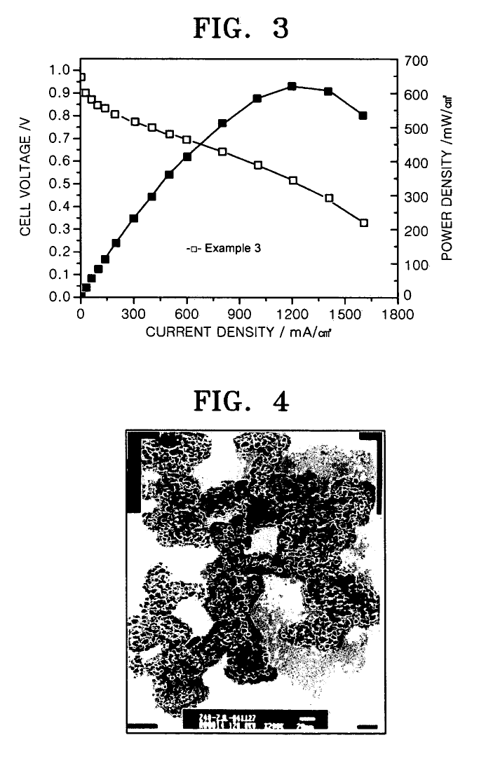

FIG. 4 is a SEM image of the catalyst. Referring to FIG. 4, the particles are uniformly distributed. It is presumed that this is because H₂PtCl₆.6H₂O was mixed with HAuCl₄.4H₂O and Al(NO₃)₃.9H₂O to prepare a uniform catalyst precursor and the precursor forms a complex with ethylene glycol. The catalyst was used to manufacture a unit cell. The performance of the cell was measured and the results are illustrated in FIG. 3 in which the white boxes refer to the cell voltage as a function of current density and the dark boxes refer to the power density as a function of the current density. In the performance test, oxygen was used as an oxidant and hydrogen containing 50 ppm of CO was used as a fuel. Referring to FIG. 3, the operating voltage is high.

### EXAMPLE 4

### 48.5 wt % Pt-0.052 wt % Au-2.91 wt % Al₂O₃/C Electrochemical Catalyst of an Example of the Present Invention

3.3 mg of HAuCl₄.4H₂O and 0.63 g of Al(NO₃)₃.9H₂O were dissolved in 4 mL of an aqueous solution of ethylene glycol (water content 60 vol %) to prepare a uniform solution. 2.0 g of 50 wt % Pt/C catalyst was added to the solution and stirred for 1 hour to prepare a uniform mixture. The mixture was heated to 90° C. to evaporate the solvent until the surface of the mixture was dried. Then, the mixture was dried in a vacuum at 150° C. for 8 hours. Finally, the dried mixture was heated at a rate of 2° C./min and thermally treated at 300° C. for 12 hours under 50 vol % H₂/N₂ atmosphere.

### EXAMPLE 5

### 58.2 wt % Pt-0.052 wt % Au-2.91 wt % Al₂O₃/C Electrochemical Catalyst of an Example of the Present Invention

3.3 mg of HAuCl₄.4H₂O and 0.63 g of Al(NO₃)₃.9H₂O were dissolved in 4 mL of an aqueous solution of ethylene glycol (water content 10 vol %) to prepare a uniform solution. 2.0 g of 60 wt % Pt/C catalyst was added to the solution and stirred for 1 hour to prepare a uniform mixture. The mixture was heated to 90° C. to evaporate the solvent until the surface of the mixture was dried. Then, the mixture was dried in a vacuum at 150° C. for 8 hours. Finally, the dried mixture was heated at a rate of 2° C./min and thermally treated at 300° C. for 12 hours under 5 vol % H₂/N₂ atmosphere.

### EXAMPLE 6

### 27.4 wt % Pt-0.51 wt % Au-2.86 wt % Fe₂O₃/C Electrochemical Catalyst of an Example of the Present Invention

11.1 mg of HAuCl₄.4H₂O and 0.1495 g of Fe(NO₃)₃.9H₂O were dissolved in 2.0 mL of an aqueous solution of ethylene glycol (water content 50 vol %) to prepare a uniform solution. 1.0 g of 28.4 wt % Pt/C catalyst was added to the solution and stirred for 1 hour to prepare a uniform mixture. The mixture was heated to 90° C. to evaporate the solvent until the surface of the mixture was dried. Then, the mixture was dried in a vacuum at 150° C. for 8 hours. Finally, the dried mixture was heated at a rate of 1° C./min and thermally treated at 400° C. for 4 hours under 5 vol % H₂/N₂ atmosphere.

The catalyst was used to manufacture a unit cell. The performance of the cell was measured and the results are illustrated in FIG. 2 in which the white boxes refer to the cell voltage as a function of current density and the dark boxes refer to the power density as a function of the current density. In the performance test, air was used as an oxidant and hydrogen containing 50 ppm of CO was used as a fuel. Referring to FIG. 2, the power density and voltage characteristics are high.

### EXAMPLE 7

### 39 wt % Pt-5.0 wt % Au-10 wt % Fe₂O₃/C Electrochemical Catalyst of an Example of the Present Invention

A catalyst was prepared in the same manner as in Example 6, except that 123 mg of HAuCl₄.4H₂O and 149 mg of Fe(NO₃)₃.9H₂O were dissolved in 2.0 mL of an aqueous solution of ethylene glycol (water content 10 vol %) to prepare a uniform solution, and then 1.0 g of 46.0 wt % Pt/C catalyst was added to the solution and stirred for 1 hour to prepare a uniform mixture.

### EXAMPLE 8

### 41.9 wt % Pt-1.5 wt % Au-7.5 wt % Fe₂O₃/C Electrochemical Catalyst of an Example of the Present Invention

A catalyst was prepared in the same manner as in Example 6, except that 34.5 mg of HAuCl₄.4H₂O and 104 mg of Fe(NO₃)₃.9H₂O were dissolved in 2.0 mL of an aqueous solution of ethylene glycol (water content 2 vol %) to prepare a uniform solution, and then 1.0 g of 46.0 wt % Pt/C catalyst was added to the solution and stirred for 1 hour to prepare a uniform mixture.

### EXAMPLE 9

### 17.0 wt % Pt-0.5 wt % Au-15.0 wt % TiO₂/C Electrochemical Catalyst of an Example of the Present Invention

15.5 mg of HAuCl₄.4H₂O was dissolved in 2.3 mL of ethylene glycol and mixed with 1.7 mL of an aqueous solution of H₂PtCl₆ 6H₂O in ethylene glycol (7.586×10⁻⁴ mol Pt/mL) and 0.5 g of a ethylene glycol solution of Ti(EG)ₓ (Ti content 26.4 wt %) to prepare a uniform solution. 1.0 g of Vulcan XC-72 conductive carbon (BET surface area 235 m²/g) was added to the solution and stirred for 1 hour to prepare a uniform mixture. The mixture was heated to 90° C. to evaporate the solvent until the surface of the mixture was dried. Then, the mixture was dried in a vacuum at 100° C. for 24 hours. Finally, the dried mixture was heated at a rate of 15° C./min and thermally treated at 400° C. for 4 hours under 5 vol % H₂/Ar atmosphere.

### EXAMPLE 10

### 17.0 wt % Pt-0.5 wt % Au-15.0 wt % TiO₂/C Electrochemical Catalyst of an Example of the Present Invention

15.5 mg of HAuCl₄.4H₂O was dissolved in 2.3 mL of ethylene glycol and mixed with 1.7 mL of an aqueous solution of H₂PtCl₆.6H₂O in ethylene glycol (7.586×10⁻⁴ mol Pt/mL) and 0.5 g of a ethylene glycol solution of Ti(EG)ₓ (Ti content 26.4 wt %) to prepare a uniform solution. 1.0 g of BP 2000 conductive carbon (BET surface area 1450 m²/g) was added to the solution and stirred for 1 hour to prepare a uniform mixture. The mixture was heated to 90° C. to evaporate the solvent until the surface of the mixture was dried. Then, the mixture was dried in a vacuum at 100° C. for 24 hours. Finally, the dried mixture was heated at a rate of 0.2° C./min and thermally treated at 200° C. for 8 hours under 10 vol % H₂/Ar atmosphere.

### EXAMPLE 11

### 5.4 wt % Pt-0.51 wt % Au-2.86 wt % Fe₂O₃/C Electrochemical Catalyst of an Example of the Present Invention

A catalyst was prepared in the same manner as in Example 6, except that 11.7 mg of HAuCl₄.4H₂O and 0.238 mg of Fe(NO₃)₃.9H₂O was dissolved in 3.5 mL of ethylene glycol and mixed with 0.4 mL of an aqueous solution of H₂PtCl₆.6H₂O in ethylene glycol (7.586×10⁻⁴ mol Pt/mL) to prepare a uniform solution, and then 1.0 g of Vulcan XC-72 conductive carbon was added to the solution and stirred for 1 hour to prepare a uniform mixture.

### COMPARATIVE EXAMPLE 1

The Pt/C catalyst used in Example 6 was used.

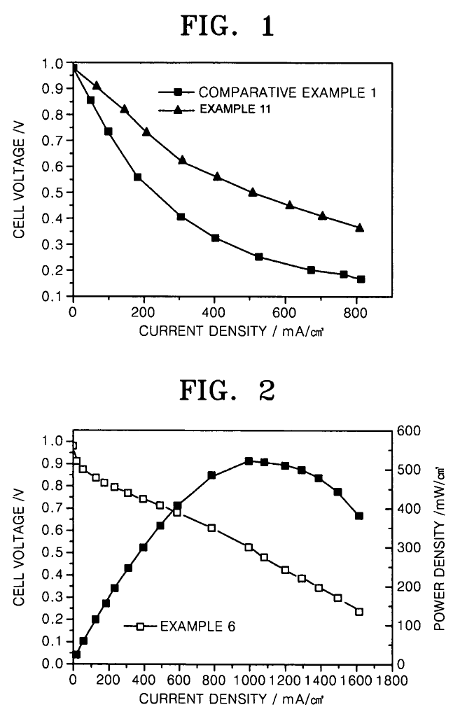

The catalyst prepared in Example 11 and the Pt/C catalyst of Comparative Example 1 were used to manufacture unit cells. The performance of the cells was measured and the results are illustrated in FIG. 1. In the performance test, air was used as an oxidant and hydrogen containing 100 ppm of CO was used as a fuel. Referring to FIG. 1, the performance of Example 11 is much better than that of Comparative Example 1. It is presumed that since Au has stronger activity to CO oxidation than hydrogen oxidation, the catalyst containing Au has high CO tolerance.

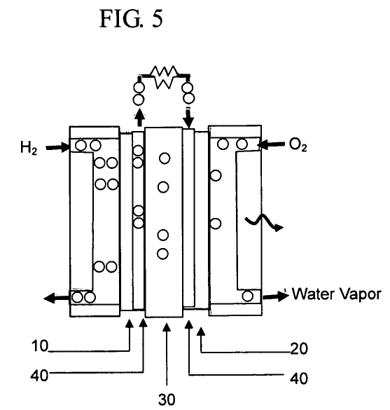

According to the embodiment shown in FIG. 5, a fuel cell includes an anode 10, a cathode 20, and a polymer electrolyte membrane 30 that physically separates the anode 10 and the cathode 20. Hydrogen is supplied to the 10 anode and oxygen is supplied to the cathode 20. When the anode 10 and the cathode 20 are connected to form a circuit (for example, by being connected to an external power consumption circuit), an operation of the fuel cell is initiated. A catalyst 40 comprises the supported catalyst according to aspects of the present invention.

While described in terms of its use in a PEFC, it is understood that aspects of the invention can be used in other contexts and/or in other types of fuel cells.

While aspects of the present invention have been particularly shown and described with reference to exemplary embodiments thereof, it will be understood by those of ordinary skill in the art that various changes in form and details may be made therein without departing from the spirit and scope of the present invention as defined by the following claims and equivalents thereof.

What is claimed is:

1. A carbon monoxide tolerant supported electrochemical catalyst for a proton exchange membrane fuel cell (PEFC), comprising:
a support; and
PtAu-MₓO_{y} supported on the support,
wherein:
x is 1, 2, or 3,
y is 1, 2, 3, or 4,
M is at least one transition metal selected from the group consisting of Fe, Al, Si, Ti, Zr, Mn, Ce, and Co,
an amount of the Pt is 5-60 wt % based on the total weight of the support and electrochemical catalyst,
an amount of the Au is 0.01-10 wt % based on the total weight of the support and electrochemical catalyst, and
an amount of the MₓO_{y} is 0.1-20 wt % based on the total weight of the support and electrochemical catalyst.

2. The catalyst of claim 1, wherein the MₓO_{y} is an oxide selected from the group consisting of Fe₂O₃, Al₂O₃, SiO₂, TiO₂, ZrO₂, MnO₂, CeO₂, Fe₃O₄, and Co₃O₄.

3. The catalyst of claim 1, wherein the support is activated carbon, conductive carbon, graphite, nano-carbon tube, nano-carbon fiber, carbon molecular sieve, or a Pt/C catalyst which is supported on the above-described supports and contains 5-60 wt % of Pt.

4. A method of preparing a catalyst comprising:
dissolving a Pt precursor and an Au precursor in a solvent including an alcohol or a mixture of water and an alcohol to form a uniform solution of active components;
mixing the solution and a support;
surface-drying the mixture by heating the mixture to evaporate the solvent and completely drying the mixture at a higher temperature than a surface-drying temperature; and
performing a thermal treatment on the mixture under an H₂/inert gas atmosphere.

5. The method of claim 4, wherein the solvent is a C₂-C₈ binary alcohol, a ternary alcohol, or a mixture of the C₂-C₈ binary alcohol or the ternary alcohol and water in which an amount of the water in the solvent is in a range of at or between 0 and 60 vol % of the mixture.

6. The method of claim 4, wherein the solvent is ethylene glycol or an aqueous solution thereof.

7. The method of claim 4, wherein the inert gas is Ar, He or N₂ and the content of H₂ in the H₂/inert gas is in a range at or between 0 and 90 vol % of the H₂/inert gas atmosphere.

8. The method of claim 4, wherein a heating rate is in a range at or between 0.1 20° C./min and 20° C./min.

9. The method of claim 4, wherein a thermal treatment temperature is in a range at or between 200° C. and 600° C.

10. The method of claim 4, wherein a surface-drying temperature is in a range at or between 50° C. and 95° C.

11. The method of claim 4, wherein the higher temperature than a surface-drying temperature at which the mixture is completely dried is in a range at or between 60° C. and 150° C.

12. The method of claim 4, wherein the drying the mixture at a higher temperature than a surface-drying temperature is performed for at or between 2 hours and 24 hours.

13. The method of claim 4, wherein the thermal treatment is performed for at or between 0.5 and 12 hours.

14. A fuel cell comprising the catalyst of claim 1.

15. The fuel cell of claim 14, wherein the fuel cell comprises a proton exchange membrane fuel cell (PEFC).

16. A carbon monoxide tolerant supported electrochemical catalyst for a proton exchange membrane fuel cell (PEFC) manufactured according to the method of claim 4.

17. The catalyst of claim 1, wherein the MₓO_{y} is Fe₂O₃, Al₂O₃, SiO₂, TiO₂, ZrO₂, MnO₂, CeO₂, Fe₃O₄, Co₃O₄, or combinations thereof.

18. The catalyst of claim 1, wherein the support is activated carbon, conductive carbon, graphite, nano-carbon tube, nano-carbon fiber, carbon molecular sieve, a Pt/C catalyst which is supported on the above-described supports and contains 5-60 wt % of Pt, or combinations thereof.

19. The method of claim 4, wherein:
the dissolving further comprising including an additive comprising M in the uniform solution such that the prepared catalyst comprises PtAu-MₓO_{y} supported on the support,
x is 1, 2, or 3,
y is 1, 2, 3, or 4,
the M is at least one transition metal selected from the group consisting of Fe, Al, Si, Ti, Zr, Mn, Ce, and Co,
an amount of the Pt is 5-60 wt % based on the total weight of the support and electrochemical catalyst,
an amount of the Au is 0.01-10 wt % based on the total weight of the support and electrochemical catalyst, and
an amount of the MₓO_{y} is 0.1-20 wt % based on the total weight of the support and electrochemical catalyst.
